(19) United States
(12) Patent Application Publication
(10) Pub. No.: US 2025/0015416 A1
(43) Pub. Date: Jan. 9, 2025

(54) AUTOMATIC BATTERY SWAPPING DEVICE AND AGV

(71) Applicant: BYD COMPANY LIMITED, SHENZHEN (CN)

(72) Inventor: Lipeng WANG, Shenzhen (CN)

(21) Appl. No.: 18/898,346

(22) Filed: Sep. 26, 2024

Related U.S. Application Data
(63) Continuation of application No. PCT/CN2023/078437, filed on Feb. 27, 2023.

(30) Foreign Application Priority Data
Jun. 23, 2022 (CN) 202221615925.3

(51) Int. Cl. H01M 50/244

(52) U.S. Cl. CPC H01M 50/244; H01M 2220/20

(57) ABSTRACT

A device for swapping a battery is provided, includes: a device body, a thrust assembly, a sensor, and an adjustment assembly. The thrust assembly is disposed in the device body, is movable in the device body, and includes an attraction member, where the attraction member is configured to extend out of or retract into the device body and configured to attract or release the battery in a vehicle. The sensor is disposed in the device body and configured to detect a position of the attraction member relative to the battery. The adjustment assembly is disposed in the device body, is movable in the device body, and is connected to the thrust assembly to adjust the position of the attraction member relative to the battery.

### CROSS-REFERENCE TO RELATED APPLICATIONS

This application is a continuation application of International Patent Application No. PCT/CN2023/078437, filed on Feb. 27, 2023, which is based on and claims priority to and benefits of Chinese Patent Application No. 202221615925.3, filed on Jun. 23, 2022. The entire content of all of the above-referenced applications is incorporated herein by reference.

### FIELD

The present disclosure relates to an automatic battery swapping device and an Automated Guided Vehicle (AGV).

### BACKGROUND

AGV vehicle is an automatic guided transport vehicle. In the existing technology, there are two methods are usually used when the battery of an AGV vehicle needs to be charged. One is to replace the battery in the AGV vehicle manually, which has high labor costs, low degree of automation, and low battery replacement efficiency. The other method uses an automatic battery swapping device to replace the battery. However, the existing automatic battery swapping device is not provided with a position adjustment mechanism. During the process of taking the battery in the AGV vehicle, the pick-and-place mechanism of the automatic battery swapping device is in contact with the battery. The contact position is prone to deviation, resulting in uneven stress on the pick-and-place mechanism, affecting the efficiency of automatic battery swapping.

### SUMMARY

The present disclosure is to provide a new technology proposal relating to an automatic battery swapping device.

According to a first aspect of the present disclosure, a device for swapping a battery is provided, including: a device body; a thrust assembly disposed in the device body, being movable in the device body, and comprising an attraction member, the attraction member configured to extend out of or retract into the device body and configured to attract or release the battery in a vehicle; a sensor disposed in the device body and configured to detect a position of the attraction member relative to the battery; and an adjustment assembly disposed in the device body, being movable in the device body, and connected to the thrust assembly to adjust the position of the attraction member relative to the battery.

In an embodiment, the attraction member is configured to switch between a first position and a second position. When the attraction member is in the first position, the attraction member extends out of the device body to attract the battery. When the attraction member is in the second position, the attraction member is located in the device body to release the battery.

In an embodiment, the thrust assembly further includes: a first driving member disposed in the device body, and connected to the adjustment assembly; a push rod, a first end of the push rod connected to the first driving member, and a second end of the push rod connected to the attraction member, wherein the first driving member drives the attraction member between the first position and the second position through the push rod.

In an embodiment, the device for swapping a battery further includes a supply battery disposed in the device body. The attraction member is an electromagnetic chuck. When the attraction member is in the first position, the supply battery supplies a power to the electromagnetic chuck, and the electromagnetic chuck generates an attraction force. When the attraction member is in the second position, the supply battery stops supplying the power to the electromagnetic chuck, and the electromagnetic chuck stops generating the attraction force.

In an embodiment, the adjustment assembly includes a first adjustment member. The first adjustment member is connected to the thrust assembly and configured to adjust the position of the attraction member in the first direction. The adjustment assembly also includes
a second adjustment member. The second adjustment member is connected to the thrust assembly and configured to adjust the position of the attraction member in the second direction. The first direction is different from the second direction.

In an embodiment, the first adjustment member includes: a second driving member; a screw rod connected to the second driving member; a guide rail spaced apart from and in parallel to the screw rod; a sliding block slidably disposed on the guide rail. The screw rod passes through the sliding block, and the sliding block is connected to the thrust assembly.

In an embodiment, the guide rail extends in a horizontal direction and the sliding block slides in the horizontal direction relative to the guide rail, so as to be used for adjusting the position of the attraction member in the horizontal direction.

In an embodiment, the first adjustment member further includes a plurality of limiting members respectively provided at both ends of the screw rod and respectively provided at both ends of the guide rail.

In an embodiment, the first adjustment member further includes a first encoder disposed on the guide rail measure the movement distance of the sliding block.

In an embodiment, the second adjustment member includes: a third driving member; a fourth driving member spaced apart from the third driving member in the second direction and connected to the thrust assembly; a telescopic rod disposed between the third driving member and the fourth driving member. The third driving member drives the telescopic rod to extend out in the second direction, and the fourth driving member drives the telescopic rod to retract in in the second direction, so as to be used for adjusting the position of the thrust assembly in the second direction.

In an embodiment, the third driving member and the fourth driving member are spaced apart in the vertical direction, so as to be used for adjusting the position of the thrust assembly in the vertical direction.

In an embodiment, the second adjustment member further includes a second encoder. One end of the second encoder is connected to the third driving member, and the other end of the second encoder is connected to the fourth driving member, to measure the movement distance of the telescopic rod in the second direction.

In an embodiment, the device for swapping a battery further includes a guide groove disposed in the device body, the extension direction of guide groove is the same as the moving direction of the attraction member. The guide groove is used for placing the battery in the AGV, and the battery slides in the guide groove when the attraction member switches between the first position and the second position.

In an embodiment, a plurality of rollers are provided in the guide groove. The rollers are spaced apart in the extension direction of the guide groove.

In an embodiment, the device for swapping a battery further includes a controller disposed in the device body, which is communicated to the sensor and the adjustment assembly.

According to a second aspect of the present disclosure, an AGV is provided, which is applied to the device for swapping a battery described in the above embodiment, including: an vehicle body; a battery, the battery is disposed in the vehicle body, and when the attraction member is in the first position, the attraction member extending out of the device body, and attracting the battery; when the attraction member is in the second position, the attraction member is located in the device body and releasing the attracted battery; an detection barcode, the detection barcode is provided on the outer wall surface of the battery, and the detection member/sensor is configured to scan the detection barcode to obtain the location information of the battery, and the device for swapping a battery adjusting the position of the attraction member according to the obtained location information of the battery.

The technical effect of the embodiments of the present disclosure includes the follows.

Embodiments of the present disclosure provide a device for swapping a battery. The detection member can detect the position of the attraction member relative to the battery in the AGV, then the adjustment assembly can adjust the position of the attraction member according to the detection result of the detection member, so as to ensure that the attraction part can align with the central area of the battery and balance the stress of the thrust assembly. It is convenient for the thrust assembly to drag the battery to the device body through the attraction member, and perform the battery swap operation to improve the battery swapping efficiency. At the same time, the present disclosure uses an attraction member to attract or release the battery, which is easier to take and is conducive to further improving the battery swapping efficiency.

Other features and advantages of the present disclosure will become apparent from the following detailed description of embodiments of the present disclosure with reference to the accompanying drawings.

### BRIEF DESCRIPTION OF THE DRAWINGS

The accompanying drawings, which are incorporated in and constitute a part of this specification, illustrate embodiments of the disclosure and together with the description, serve to explain the principles of the disclosure.

FIG. 1 is a schematic structural diagram of the automatic battery swapping device for AGV according to an embodiment of the present disclosure;

FIG. 2 is a schematic structural diagram of a thrust assembly of an automatic battery swapping device according to an embodiment of the present disclosure;

FIG. 3 is a schematic structural diagram of the first adjustment member of the automatic battery swapping device according to an embodiment of the present disclosure;

FIG. 4 is a schematic structural diagram of the second adjustment member of the automatic battery swapping device according to an embodiment of the present disclosure.

### REFERENCE SIGNS

device body 10;
thrust assembly 20; first driving member 21; push rod 22; attraction member 23;
detection member 30;
adjustment assembly 40; first adjustment member 41; second driving member 411; screw rod 412; guide rail 413; sliding block 414; limiting members 415; second adjustment member 42; third driving member 421; fourth driving member 422; telescopic rod 423; second encoder 424;
supply battery 51; guide groove 52; rollers 53; first wireless transceiver device 54;
vehicle body 60;
battery 71; detection barcode 72; laser navigator 73; reflector 74; second wireless transceiver device 75; vehicle controller 76; backup battery 77; and cargo fork 78.

### DETAILED DESCRIPTION

Various embodiments of the present disclosure will now be described in detail with reference to the accompanying drawings. It should be noted that the relative arrangement of components and steps, numerical expressions, and numerical values set forth in these examples do not limit the scope of the disclosure unless otherwise specifically stated.

The following description of at least one embodiment is merely illustrative and does not limit the disclosure, its application or uses.

Techniques, methods and devices known to those of ordinary skill in the relevant art may not be discussed in detail, but should be considered as a part of the specification.

In all examples shown and discussed herein, any values are to be illustrative only but not as limitation. Accordingly, other examples of the embodiments may have different values.

It should be noted that similar reference numerals and letters refer to similar items in the following figures, so that once an item is defined in one figure, it does not need further discussion in subsequent figures.

Features referred to in the description and claims of the present disclosure that refer to the terms “first” and “second” may include one or more of these features, either explicitly or implicitly. In the description of the present disclosure, “plurality” means two or more unless otherwise specified. In addition, “and/or” in the description and claims indicates at least one of the connected objects, and the character “/” generally indicates that the related objects are in an “or” relationship.

In the description of the present disclosure, if the terms, “center”, “longitudinal”, “transverse”, “length”, “width”, “thickness”, “upper”, “lower”, “front” and “rear” are used, “Left”, “Right”, “Vertical”, “Horizontal”, “Top”, “Bottom”, “Inside”, “Outside”, “Clockwise”, “Counterclockwise”, “Axis”, “Diameter”, “circumferential direction”, etc. are based on the orientation or positional relationship shown in the drawings, it is only for the convenience of describing the present disclosure and simplifying the description, and does not indicate or imply that the device or element referred to must have orientations, construction and operation in the orientations. Therefore, the terms should not be limitations on the disclosure.

In the description of the present disclosure, it should be noted that, unless otherwise explicitly stated and limited, the terms “installation,” “connection,” and “connection” should be understood in a broad sense. For example, it can be a fixed connection, a detachable connection, or an integral connection; it can be a mechanical connection, or it can be an electrical connection; it can be a direct connection, or it can be an indirect connection through an intermediate medium, or it can be an internal connection to two components. For those of ordinary skill in the art, the meanings of the above terms in this disclosure can be understood according to circumstances.

An automatic battery swapping device or a device for swapping a battery provided in the embodiments of the present disclosure is described below with reference to the accompanying drawings.

As shown in FIGS. 1 to 4, an automatic battery swapping device provided in the embodiments of the present disclosure includes a device body 10, a thrust assembly 20, detection member 30 (e.g., a sensor) and an adjustment assembly 40.

In an embodiment, the thrust assembly 20 is provided/disposed in the device body 10 and is movable in the device body 10. The thrust assembly 20 includes an attraction member 23 which can extend out or retract into the device body 10. The attraction member 23 is used/configured for attracting or releasing a battery 71 in the AGV. The detection member 30 is provided in the device body 10 and are used for detecting the position of the attraction member 23 relative to the battery 71 in the AGV. The adjustment assembly 40 is movably provided in the device body 10 and is connected to the thrust assembly 20. The adjustment assembly 40 adjusts the position of the attraction member 23 relative to the battery 71 in the AGV according to the detection result of the detection member 30.

In other words, the automatic battery swapping device according to the embodiment of the present disclosure is mainly used for automatic battery swapping of AGV vehicles. AGV is an automatic guided transport vehicle. AGV vehicles are transport vehicles equipped with electromagnetic or optical automatic guidance devices that can travel along prescribed guidance paths and have safety protection and various transfer functions. Referring to FIG. 1, when the battery 71 of the AGV vehicle has low power or the power is exhausted, the automatic battery swapping device of the present disclosure can be used for performing automatic battery swapping operations on the AGV vehicle, thereby the battery swapping operation being automatic, helping to reduce labor costs and improving battery exchange efficiency.

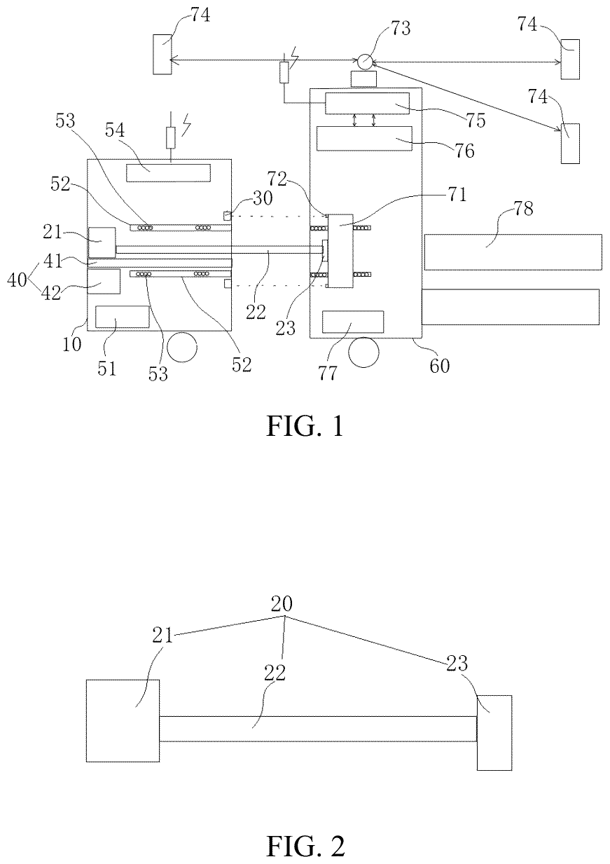

As shown in FIG. 1, the automatic battery swapping device of the present disclosure mainly consists of a device body 10, a thrust assembly 20, detection member 30 and an adjustment assembly 40. Among them, the thrust assembly 20 is installed in the device body 10 and is movable in the device body 10. Referring to FIGS. 1 and 2, the thrust assembly 20 includes an attraction member 23 that can extend out or retract into the device body 10. The attraction member 23 is mainly used for attracting or releasing the battery 71 in the AGV. During the process of automatic battery swapping, when the attraction member 23 extends out of the device body 10, the attraction member 23 is in the same position as the battery 71 in the AGV. In addition, the attraction member 23 attracts the battery 71, and then the attraction member 23 can drag the battery 71 onto the device body 10 during the process of retracting the device body 10. In this case, the attraction member 23 releases the battery 71, and then sends the battery 71 to the charging station for charging through the automatic battery replacement device. In the present disclosure, the attraction member 23 is used to attract and release the battery 71, which is simpler and more convenient to take, which is beneficial to further improving the battery replacement efficiency.

Referring to FIG. 1, the detection member 30 is installed in the device body 10 and may be a sensor. The detection member 30 can be used for detecting the position of the attraction member 23 relative to the battery 71 in the AGV. The adjustment assembly 40 is movably installed in the device body 10 and is connected to the thrust assembly 20. Referring to FIG. 1, the adjustment assembly 40 can adjust the position of the attraction member 23 relative to the battery 71 in the AGV according to the detection results of the detection member 30. Whether the position of the attraction member 23 is centered relative to the battery 71 in the AGV can be determined through the detection member 30. If it is not centered, the position of the attraction member 23 can be adjusted through the adjustment assembly 40 to ensure that the attraction member 23 can be aligned with the central area of the battery 71, so that the stress of the thrust assembly 20 is balanced. It is convenient for the thrust assembly 20 to drag the battery 71 to the device body 10 through the attraction member 23, and perform the battery swap operation to improve the battery swapping efficiency.

Therefore, according to the automatic battery swapping device according to the embodiment of the present disclosure, the detection member 30 can detect the position of the attraction member 23 relative to the battery 71 in the AGV, and the adjustment assembly 40 can adjust the position of the attraction member 23 according to the detection result of the detection member 30, so as to ensure that the attraction member 23 can be aligned with the central area of the battery 71, so that the stress of the thrust assembly 20 is balanced. It is convenient for the thrust assembly 20 to drag the battery 71 to the device body 10 through the attraction member 23, and perform the battery swap operation to improve the battery swapping efficiency. At the same time, the present disclosure uses an attraction member 23 to attract or release the battery 71, which is easier and is conducive to further improvement of the battery swapping efficiency.

According to an embodiment of the present disclosure, the attraction member 23 is switchable between the first position and the second position. When the attraction member 23 is in the first position, it extends out of the device body 10 to be in the same position as the battery 71 in the AGV then attracts the battery 71. When the attraction member 23 is in the second position, it is located in the device body 10 and attracts the battery 71 into the device body 10, then releases the attracted battery 71. At this time, the attraction member 23 releases the battery 71, and the battery 71 is sent to the charging station for charging through the automatic battery swapping device. The automatic battery swapping operation is completed.

According to an embodiment of the present disclosure, the thrust assembly 20 further includes a first driving member 21 and a push rod 22.

In an embodiment, the first driving member 21 is provided/disposed in the device body 10, and the adjustment assembly 40 is connected to the first driving member 21. One end (e.g., a first end) of the push rod 22 is connected to the first driving member 21, and the other end (e.g., a second end) of the push rod 22 is connected to the attraction member 23. The first driving member 21 drives the attraction member 23 through the push rod 22 to switch between the first position and the second position.

That is to say, as shown in FIGS. 1 and 2, the thrust assembly 20 further includes a first driving member 21 and a push rod 22, wherein the first driving member 21 is installed in the device body 10, and the adjustment assembly 40 is connected with the first driving member 21. The first driving member 21 can be a hydraulic cylinder or a pneumatic cylinder. One end of the push rod 22 is connected to the first driving member 21, and the other is connected to the attraction member 23. The first driving member 21 can drive the push rod 22 to extend out or retract into the device body 10 so that the attraction member 23 switches between the first position and the second position. When the first driving member 21 drives the push rod 22 to extend out of the device body 10, the attraction member 23 attracts the battery 71, and then the first driving member 21 drives the push rod 22 to retract into the device body 10, and then drags the battery 71 from the AGV and retract into the device body 10 through the attraction member 23 to implement the battery exchange operation.

In some embodiments of the present disclosure, the automatic battery swapping device also includes a supply battery 51. The supply battery 51 is provided in the device body 10. The attraction member 23 is an electromagnetic chuck. The supply battery 51 powers the electromagnetic chuck and the electromagnetic chuck generates an attraction force when the attraction member 23 is in the first position. The supply battery 51 powers down the electromagnetic chuck and the electromagnetic chuck relieves the attraction force when the attraction member 23 is in the second position.

In other words, referring to FIG. 1, the automatic battery swapping device may also include a supply battery 51. The supply battery 51 is provided in the device body 10. The attraction member 23 may be an electromagnetic chuck. When the first driving member 21 in the thrust assembly 20 drives the push rod 22 to extend out of the device body 10, the electromagnetic chuck reaches the outer surface of the battery 71 (the attraction member 23 is in the first position). At this time, the automatic battery swapping device controls the supply battery 51 to supply power to the electromagnetic chuck, so that the electromagnetic chuck generates attraction force and attract the battery 71. Then the first driving member 21 drives the push rod 22 to retract into the device body 10. During this process, the electromagnetic chuck attracts the battery 71 into the device body 10 (the attraction member 23 is in the second position). At this time, the automatic battery swapping device can control the supply battery 51 to cut off power to the electromagnetic chuck, and the electromagnetic chuck's attraction force is released, and the electromagnetic chuck no longer attracts the battery 71. Finally, the battery 71 is sent to the charging station for charging through the automatic battery swapping device.

According to one embodiment of the present disclosure, referring to FIG. 1, the adjustment assembly 40 includes a first adjustment member 41 and the second adjustment member 42. The first adjusting member 41 connected to the thrust assembly 20 can be used to adjust the position of the attraction member 23 in the first direction. The second adjustment member 42 connected to the thrust assembly 20 can be used to adjust the position of the attraction member 23 in the second direction, where the first direction is different from the second direction. The first direction may be a horizontal direction, and the second direction may be a vertical direction. When the detection member 30 detects that there is a position deviation between the attraction member 23 and the battery 71, the position of the attraction member 23 in the horizontal direction and/or the vertical direction can be adjusted through the first adjustment member 41 and/or the second adjustment member 42.

In some embodiments of the present disclosure, the first adjusting member 41 includes a second driving member 411, a screw rod 412, a guide rail 413, and a sliding block 414.

In an embodiment, the screw rod 412 is connected to the second driving member 411, and the guide rail 413 is spaced apart and parallel to the screw rod 412. The sliding block 414 is slidably disposed on the guide rail 413. The screw rod 412 passes through the sliding block 414, and the sliding block 414 is connected to the thrust assembly 20. The guide rail 413 extends in the horizontal direction, and the sliding block 414 slides in the horizontal direction relative to the guide rail 413, so as to adjust the position of the attraction member 23 in the horizontal direction.

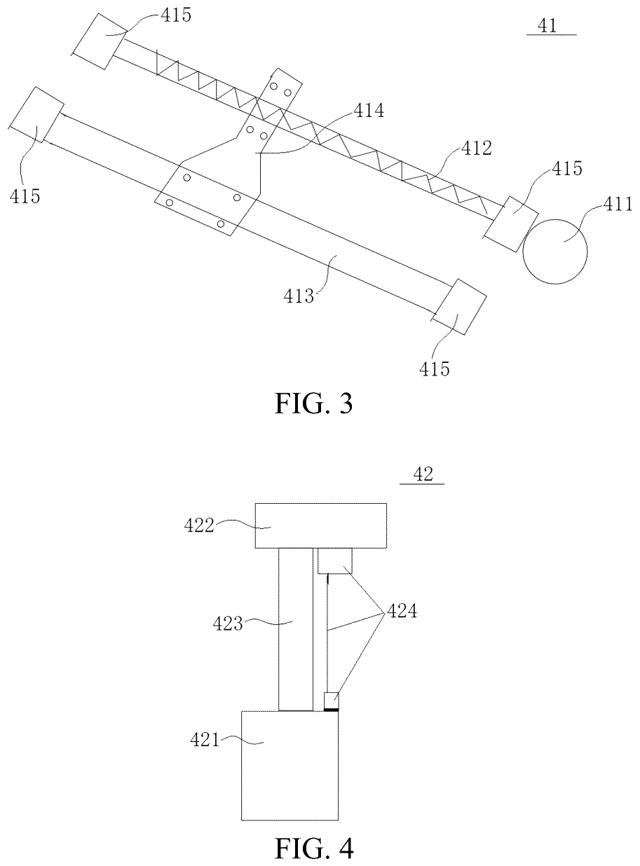

That is to say, as shown in FIG. 3, the first adjusting member 41 mainly includes a second driving member 411, a screw rod 412, guide rail 413 and a sliding block 414. Among them, the screw rod 412 is connected with the second driving member 411. The guide rail 413 is spaced apart from and in parallel to the screw rod 412. The sliding block 414 is slidably disposed on the guide rail 413, and the screw rod 412 can pass through the sliding block 414. The sliding block 414 is connected to the thrust assembly 20, and the position of the thrust assembly 20 in the first direction is adjusted by sliding the sliding block 414. The guide rail 413 can extend in the horizontal direction, and the sliding block 414 can slide in the horizontal direction relative to the guide rail 413, so as to adjust the position of the attraction member 23 in the horizontal direction.

The second driving member 411 can be a driver including a servo motor and a servo driving component. The screw rod 412 can be a ball screw which has threads. The screw rod 412 is installed on the servo motor. The servo motor drives the screw rod 412 to rotate, converting the rotational motion into linear motion, thereby driving the sliding block 414 to slide linearly along the guide rail 413 to realize the position adjustment of the first adjusting member 41 on the attraction member 23 in the horizontal direction.

In some embodiments of the present disclosure, the first adjusting member 41 further includes a plurality of limiting members 415 and a first encoder. The limiting members 415 are respectively provided at both ends of the screw rod 412, and at both ends of the guide rail 413. The first encoder is provided on the guide rail 413 to measure the movement distance of the sliding block 414.

In other words, the first adjusting member 41 may also include a plurality of limiting members 415 and a first encoder. As shown in FIG. 3, the limiting members 415 are respectively provided at both ends of the screw rod 412, and at both ends of the guide rail 413. The limiting members 415 can be configured as a limit block. By configuring the limiting members 415, the moving range of the sliding block 414 on the screw rod 412 and the guide rail 413 can be limited, so as to prevent the sliding block 414 from moving out of the screw rod 412 and the guide rail 413. The first encoder can be installed on the guide rail 413, and the first encoder can measure the movement distance of the sliding block 414.

In the present disclosure, the first adjustment member 41 (which can be called a horizontal adjustment member) adopts a structure such as a servo motor plus a ball screw. The servo motor rotates and has threads on the screw which can be mounted on the servo motor to convert the rotating motion into linear motion. The pitch of the screw can be set to 5 mm. When the servo motor rotates once, the object mounted on the screw can move 5 mm in parallel. The first encoder is installed on the guide rail 413, and the guide rail 413 is parallel to the screw. The first encoder can measure the translation of the thrust assembly 20 on the sliding block 414. The rotation of the servo motor can be controlled by the pulse emitted by the servo driver, for example, with a 5 mm lead screw, a turn is 5 mm, a turn has 20,000 pulses, that is, a pulse is sent to control

$$\frac{5}{20000} mm .$$

Then, the servo driver compares the pulses it sends with the actual pulses and controls the servo motor to rotate forward or backward. One end of the sliding block 414 is fixed on the screw, and the other end slides along the guide rail 413, and drives the thrust assembly 20 installed on the sliding block to slide along the guide rail 413, so that the servo motor drives the screw and the thrust assembly 20 on the sliding block 414 to the left or right to realize the position of the thrust assembly 20.

According to an embodiment of the present disclosure, as shown in FIG. 4, the second adjustment member 42 includes a third driving member 421, a fourth driving member 422 and a telescopic rod 423. The fourth driving member 422 and the third driving member 421 are spaced apart in the second direction, and the fourth driving member 422 is connected to the thrust assembly 20. The telescopic rod 423 is installed between the third driving member 421 and the fourth driving member 422. The third driving member 421 drives the telescopic rod 423 to extend out in the second direction, and the fourth driving member 422 drives the telescopic rod 423 to retract in in the second direction. The position of the thrust assembly 20 in the second direction can be adjusted by the extension or retraction of the telescopic rod 423 in the second direction driven by the third drive member 421 and the fourth drive member 422.

In an embodiment, referring to FIG. 4, the third driving member 421 and the fourth driving member 422 are arranged spaced apart in the vertical direction, the fourth driving member 422 is located above the third driving member 421. The third driving member 421 and the fourth driving member 422 can drive the telescopic rod 423 to telescope in the second direction, thereby adjusting the position of the thrust assembly 20 in the vertical direction.

The second adjusting member 42 may also include a second encoder 424. As shown in FIG. 4, the second encoder 424 may be a wire encoder. One end (e.g., a first end) of the second encoder 424 is connected to the third driving member 421, and the other end (e.g., a second end) is connected to the fourth driving member 422. Both the third driving member 421 and the fourth driving member 422 can use hydraulic cylinders or pneumatic cylinders. The second adjusting member 42 can drive the thrust assembly 20 to rise or fall, and the wire encoder can measure the rising or falling height.

According to an embodiment of the present disclosure, referring to FIG. 1, the automatic battery swapping device further includes a guide groove 52, which is provided in the device body 10. The extension direction of the guide groove 52 is the same as the moving direction of the attraction member 23. The guide groove 52 is used for placing the battery 71 in the AGV, and during the process of the attraction member 23 switching between the first position and the second position, the attraction member 23 in the thrust assembly 20 can attract the battery 71 in the AGV to slide along the guide groove 52 to ensure that the battery 71 can move in the set position. A plurality of rollers 53 may be provided in the guide groove 52, and the plurality of rollers 53 may be arranged spaced apart in the extension direction of the guide groove 52. By disposing the roller 53 in the guide groove 52, the sliding efficiency of the battery 71 on the guide groove 52 can be improved. There are two guide grooves 52, which are spaced apart and arranged in parallel. Each guide groove 52 is provided with a plurality of rollers 53. The attraction member 23 can attract the battery 71 to slide along the two guide grooves 52.

According to an embodiment of the present disclosure, the automatic battery swapping device further includes a controller. The controller is provided in the device body 10. The controller is communicated to the detection member 30 through signals, and the controller is communicated to the adjustment assembly 40 through signals.

In other words, the automatic power exchange device also includes a controller, which is installed in the device body 10, communicates to the detection member 30 through signals, and communicates to the adjustment assembly 40 through signals. During the process of swapping the battery of the automatic battery swapping device, first, the detection member 30 (e.g., sensors) is used for detecting whether the position of the electromagnetic chuck (attraction member 23) is centered relative to the battery 71. If the attraction member 23 is not centered relative to the battery 71, the detection member 30 can send a signal to the controller to request the horizontal adjustment device (the first adjustment member 41) to move left or right in the horizontal direction until the position of the electromagnetic chuck detected by the detection member 30 is within the error range relative to the horizontal position of the battery 71. If the detection member 30 detects that the position of the electromagnetic chuck is upward or downward relative to the battery 71, a signal can be sent to the control part to request the vertical adjustment device (the second adjustment member 42) to move downward or upward until the position of the electromagnetic chuck detected by the detection member 30 is within the error range relative to the vertical position of the battery 71.

The detection member 30 can then calculate the distance between the parked location of the automatic battery swapping device and the surface movement of the battery 71 in the AGV, and send a signal to the controller to control the thrust assembly 20 to extend according to the calculated distance, thereby ensuring that the automatic battery swapping device is accurately docked with the battery 71.

When the thrust assembly 20 pushes the electromagnetic chuck to reach the outer surface of the cover of the battery 71, the controller can control the supply battery 51 to supply power to the electromagnetic chuck, and the electromagnetic chuck can attract the battery 71. The controller may then request the thrust assembly 20 to pull the battery 71 onto the guide groove 52 in the device body 10. When the battery 71 is pulled to the set position of the guide groove 52, the controller controls the supply battery 51 to cut off power to the electromagnetic chuck. The electromagnetic chuck release the battery 71, and then the automatic battery swapping device sends the battery 71 to the charging station for charging, so as to realize the battery swapping operation of the automatic battery swapping device.

Of course, for those skilled in the art, the automatic battery swapping device is also equipped with the first wireless transceiver device 54 and other structures, and the working principle of the automatic battery swapping device can be realized, and will not be described in detail in this disclosure.

In summary, according to the automatic battery swapping device of the embodiment of the present disclosure, the detection member 30 can detect the position of the attraction member 23 relative to the battery 71 in the AGV, and the adjustment assembly 40 can adjust the position of the attraction member 23 according to the detection result of the detection member 30, to ensure that the attraction member 23 can be aligned with the central area of the battery 71 and balance the stress of the thrust assembly 20. It is convenient for the thrust assembly 20 to drag the battery 71 to the device body 10 through the attraction member 23, and perform the battery swap operation to improve the battery swapping efficiency. At the same time, the present disclosure uses an attraction member 23 to attract or release the battery 71, which is easier to take and is conducive to further improvement of the battery swapping efficiency.

According to a second aspect of the present disclosure, an AGV is provided, which is applied to the automatic battery swapping device in the above embodiment. As shown in FIG. 1, the AGV mainly consists of a vehicle body 60, a battery 71 and a detection barcode 72. The battery 71 is provided in the vehicle body 60. When the attraction member 23 is in the first position, the attraction member 23 in the thrust assembly 20 can extend out of the device body 10 and attract the battery 71. When the attraction member 23 is in the second position, the attraction member 23 is located in the device body 10, and the attraction member 23 release the attracted battery 71. The detection barcode 72 is provided on the surrounding edges of the outer wall surface of the battery 71. The detection member 30 is used to scan the detection barcode 72 to obtain the position of the battery 71. The automatic battery swapping device adjusts the position of the attraction member 23 according to the obtained location information of the battery 71.

Referring to FIG. 1, the AGV vehicle also includes a second wireless transceiver device 75, a laser navigator 73, a reflector 74, a vehicle controller 76, a backup battery 77, a cargo fork 78 and other structures. From the perspective of battery power in AGV, when the battery 71 needs to be swapped, the AGV can be navigated through the laser navigator 73 to the corresponding coordinate point of the automatic battery replacement device and open the cover so that the battery 71 faces the attraction member 23. The detection member 30 on the automatic battery swapping device has a detection barcode 72 on the surrounding edges of the battery 71 to detect whether the position of the electromagnetic chuck (the attraction member 23) is centered relative to the battery 71. If the attraction member 23 is not centered relative to the battery 71, the detection member 30 can send a signal to the controller to request the horizontal adjustment device (the first adjustment member 41) to move left or right in the horizontal direction until the position of the electromagnetic chuck detected by the detection member 30 is within an error range relative to the horizontal position of the battery 71. If the detection member 30 detects that the position of the electromagnetic chuck is upward or downward relative to the battery 71, a signal can be sent to the control part to request the vertical adjustment device (the second adjustment member 42) to move downward or upward until the position of the electromagnetic chuck detected by the detection member 30 is within the error range relative to the vertical position of the battery 71.

Then, the detector can then calculate the distance between the parked location of the automatic battery swapping device and the surface travel of the battery 71 in the AGV, and send a signal to the controller to control the thrust assembly 20 to extend according to the calculated travel, thereby ensuring that the automatic battery swapping device and the battery 71 are accurately docking.

When the thrust assembly 20 pushes the electromagnetic chuck to reach the outer surface of the cover of the battery 71, the controller can control the supply battery 51 to supply power to the electromagnetic chuck, and the electromagnetic chuck can attract the battery 71. The controller may then request the thrust assembly 20 to pull the battery 71 onto the guide groove 52 in the device body 10. When the battery 71 is pulled to the set position of the guide groove 52, the controller controls the supply battery 51 to cut off power to the electromagnetic chuck. The electromagnetic chuck release the battery 71, and then the automatic battery swapping device sends the battery 71 to the charging station for charging, so as to realize the battery swapping operation of the automatic battery swapping device.

Of course, for those skilled in the art, other structures of AGV vehicles and their working principles can be realized, and will not be described in detail in this disclosure.

Although the embodiments of the present disclosure have been shown and described above, it can be understood that, the foregoing embodiments are examples and should not be understood as limitation to the present disclosure. A person of ordinary skill in the art can make changes, modifications, replacements, or variations to the foregoing embodiments within the scope of the present disclosure.

What is claimed is:

1. A device for swapping a battery, comprising:
a device body;
a thrust assembly disposed in the device body, being movable in the device body, and comprising an attraction member, the attraction member configured to extend out of or retract into the device body and configured to attract or release the battery in a vehicle;
a sensor disposed in the device body and configured to detect a position of the attraction member relative to the battery; and
an adjustment assembly disposed in the device body, being movable in the device body, and connected to the thrust assembly to adjust the position of the attraction member relative to the battery.

2. The device according to claim 1, wherein
the attraction member is configured to switch between a first position and a second position,
when the attraction member is in the first position, the attraction member extends out of the device body to attract the battery,
when the attraction member is in the second position, the attraction member is located in the device body to release the battery.

3. The device according to claim 2, wherein the thrust assembly further comprises:
a first driving member disposed in the device body, and connected to the adjustment assembly; and
a push rod, a first end of the push rod connected to the first driving member, and a second end of the push rod connected to the attraction member, wherein the first driving member drives the attraction member between the first position and the second position through the push rod.

4. The device according to claim 2, further comprising a supply battery disposed in the device body, wherein
the attraction member comprises an electromagnetic chuck,
when the attraction member is in the first position, the supply battery supplies a power to the electromagnetic chuck, and the electromagnetic chuck generates an attraction force, and
when the attraction member is in the second position, the supply battery stops supplying the power to the electromagnetic chuck, and the electromagnetic chuck stops generating the attraction force.

5. The device according to claim 1, wherein the adjustment assembly comprises:
a first adjustment member connected to the thrust assembly, and configured to adjust the position of the attraction member in a first direction; and
a second adjustment member connected to the thrust assembly, and configured to adjust the position of the attraction member in a second direction, wherein the first direction is different from the second direction.

6. The device according to claim 5, wherein the first adjustment member comprises:
a second driving member;
a screw rod connected to the second driving member;
a guide rail spaced apart from and in parallel with the screw rod; and
a sliding block disposed on the guide rail, wherein the screw rod passes through the sliding block, and the sliding block is connected to the thrust assembly.

7. The device according to claim 6, wherein the guide rail extends in a horizontal direction, and the sliding block slides in the horizontal direction relative to the guide rail to adjust the position of the attraction member in the horizontal direction.

8. The device according to claim 6, wherein the first adjustment member further comprises a plurality of limiting members, each of two ends of the screw rod comprises one of the limiting members, and each of two ends of the guide rail comprises one of the limiting members.

9. The device according to claim 8, wherein the first adjustment member further comprises a first encoder, the first encoder is disposed on the guide rail to measure a movement distance of the sliding block.

10. The device according to claim 5, wherein the second adjustment member comprises:
a third driving member;
a fourth driving member spaced apart from the third driving member in the second direction, and connected to the thrust assembly; and
a telescopic rod disposed between the third driving member and the fourth driving member, the third driving member drives the telescopic rod to extend out in the second direction, and the fourth driving member drives the telescopic rod to retract in the second direction, to adjust the position of the thrust assembly in the second direction.

11. The device according to claim 10, wherein the third driving member and the fourth driving member are spaced apart in a vertical direction, to adjust the position of the thrust assembly in the vertical direction.

12. The device according to claim 10, wherein the second adjustment member further comprises a second encoder, a first end of the second encoder is connected to the third driving member, and a second end of the second encoder is connected to the fourth driving member, to measure a movement distance of the telescopic rod in the second direction.

13. The device according to claim 2, further comprising a guide groove disposed in the device body, an extension direction of the guide groove is the same as a moving direction of the attraction member, the guide groove is configured to place the battery in the vehicle, and the battery slides in the guide groove when the attraction member switches between the first position and the second position.

14. The device according to claim 13, wherein the guide groove comprises a plurality of rollers spaced apart in the extension direction of the guide groove.

15. The device according to claim 1, further comprising a controller disposed in the device body, and the controller communicates to the sensor and to the adjustment assembly.

16. A vehicle, applied to a device for swapping a battery, comprising:
a vehicle body;
the battery disposed in the vehicle body; and
a detection barcode disposed on an outer wall surface of the battery, wherein
the device comprises:
a device body;
a thrust assembly disposed in the device body, being movable in the device body, and comprising an attraction member, the attraction member configured to extend out of or retract into the device body, and configured to attract or release the battery;
a sensor disposed in the device body, configured to scan the detection barcode to obtain a location information of the battery, configured to detect a position of the attraction member relative to the battery, and the device adjusts the position of the attraction member according to the obtained location information of the battery; and
an adjustment assembly disposed in the device body, being movable in the device body, and connected to the thrust assembly to adjust the position of the attraction member relative to the battery;
when the attraction member is in a first position, the attraction member extends out of the device body and attracts the battery; and when the attraction member is in a second position, the attraction member is located in the device body and releases the battery.

17. The vehicle according to claim 16, wherein
the attraction member is configured to switch between the first position and the second position,
when the attraction member is in the first position, the attraction member extends out of the device body to attract the battery,
when the attraction member is in the second position, the attraction member is located in the device body to release the battery.

18. The vehicle according to claim 17, wherein the thrust assembly further comprises:
a first driving member disposed in the device body, and connected to the adjustment assembly; and
a push rod, a first end of the push rod connected to the first driving member, and a second end of the push rod connected to the attraction member, wherein the first driving member drives the attraction member between the first position and the second position through the push rod.

19. The vehicle according to claim 17, wherein the device further comprises a supply battery disposed in the device body, wherein
the attraction member comprises an electromagnetic chuck,
when the attraction member is in the first position, the supply battery supplies a power to the electromagnetic chuck, and the electromagnetic chuck generates an attraction force, and
when the attraction member is in the second position, the supply battery stops supplying the power to the electromagnetic chuck, and the electromagnetic chuck stops generating the attraction force.

20. The vehicle according to claim 16, wherein the adjustment assembly comprises:
a first adjustment member connected to the thrust assembly, and configured to adjust the position of the attraction member in a first direction; and
a second adjustment member connected to the thrust assembly, and configured to adjust the position of the attraction member in a second direction, wherein the first direction is different from the second direction.
